(19) United States
(12) Patent Application Publication
(10) Pub. No.: US 2005/0154684 A1
(43) Pub. Date: Jul. 14, 2005

(54) Method for distributing bulk mailings

(75) Inventors: Wolf-Stephan Wilke, Konstanz (DE); Armin Zimmermann, Konstanz (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 10/962,915

(22) Filed: Oct. 13, 2004

Related U.S. Application Data
(63) Continuation of application No. PCT/DE03/00852, filed on Mar. 17, 2003.

(30) Foreign Application Priority Data
Apr. 13, 2002 (DE) 102 16 336.7

(51) Int. Cl. G06F 17/60

(52) U.S. Cl. 705/401

(57) ABSTRACT

The invention relates to a method for distributing bulk. The inventive method includes the following steps: supplying the bulk mailing, whereby the individual postal articles are unaddressed, and electronically transmitting the associated destination address data from the sender to the delivery service; comparing the transmitted destination address data with the entries of an updated address database of the delivery service and in the event of a discrepancy, correcting the relevant transmitted destination address data, and; associating the transmitted and optionally corrected destination address data to the individual postal articles of this bulk mailing and accordingly applying the corresponding destination addresses, which are provided in a form that can read by the individual, to the postal articles and using the postal article processing machine to process the postal articles in accordance with the destination address data associated with each postal article.

The invention relates to a method for distributing bulk mailings, generated by the sender, using mailing processing machines, such as sorting machines.

When bulk mailings (in which every single mailing has been provided with the destination address) are processed automatically on sorting machines based on the prior art, the destination addresses on the mailings need to be read using complex reading technology.

Within this context, the reading rate is always, sometimes substantially, below 100%, i.e. some mailings can be sorted and then distributed only with a delay or only manually.

The senders' address databases are often incorrect and are normally not maintained, which means that the address details which have been put on are often already incorrect.

The physically fixed association between an address and a mailing means that forwarding when the address is incorrect is also possible only physically.

In these cases too, the mailings have to be handled manually.

U.S. Pat. No. 5,079,714 describes the handling of bulk mailings within the context of “preprocessings” prior to the delivery of mail in order to obtain an agreed discount, inter alia where a central address database is kept up-to-date and the major deliverers update their address databases by downloading the latest data affecting them from the central database.

The invention is therefore based on the object of providing a method for distributing bulk mailings which is less complex than the prior art and in which the necessary manual interventions are reduced.

The invention achieves the object by means of the features of claim 1.

In this case, the sender delivers the bulk mailing with unaddressed mailings to the postal service and sends the postal service the destination address data for the bulk mailing's mailings which are to be delivered.

The postal service then compares the sent destination address data with the entries in an up-to-date, central address database. In the event of there being no match, the sent destination address data in question are corrected. The mailing processing machine then associates the sent and possibly corrected destination address data with the individual mailings in this bulk mailing and accordingly puts the addresses onto the separated mailings in a form which can be read by humans. Next, the mailing processing machine processes the mailings further on the basis of the associated address data.

In this case, this method moves processes which previously took place in the physical domain to fast data processes in order to afford the following advantages:
a) the addresses no longer need to be read. Corresponding technology can be saved when processing bulk mailings.
b) alignment with the address database means that the addresses are normally correct.
c) alignment with the address database means that the proportion of mailings which actually still need to be forwarded physically between two distribution centers is minimized (statistical equalization effect).
d) the proportion of mailings which still reach their destination on time despite the address originally being incorrect is drastically increased.

Advantageous refinements of the invention are presented in the subclaims.

It is thus advantageous for each bulk mailing's destination address data which are sent with an ID number, are checked using the postal service's address database and are possibly corrected to be stored under this ID number in a destination address memory. The destination addresses are then retrieved from this destination address memory by that controller in a mailing processing machine for associating the destination addresses with the individual mailings and processing on the basis of the associated destination address data into which the same ID number, which also flags the unaddressed bulk mailing, has been input or read in.

It is also advantageous if, to ensure that the postal service's address database is up-to-date, the entries are changed on the basis of forwarding information coming from customer communications.

To reduce the proportion of addresses which are supplied incorrectly by the sender, it is advantageous to send the destination address data corrected on the basis of the alignment with the postal service's address database to the sender and hence to update the latter's address database.

It is particularly advantageous to sort the destination address data in the deliverers' distribution order and to put the destination addresses onto the mailings in this order. As a result, it is possible to dispense with an otherwise necessary sorting operation.

If the destination addresses are additionally also printed in coded, machine-readable form, e.g. in the form of a bar code, then instead of OCR readers only bar code readers are now necessary for later processing processes on further mailing processing machines.

The invention is explained in more detail below using an exemplary embodiment with reference to the drawing, in which

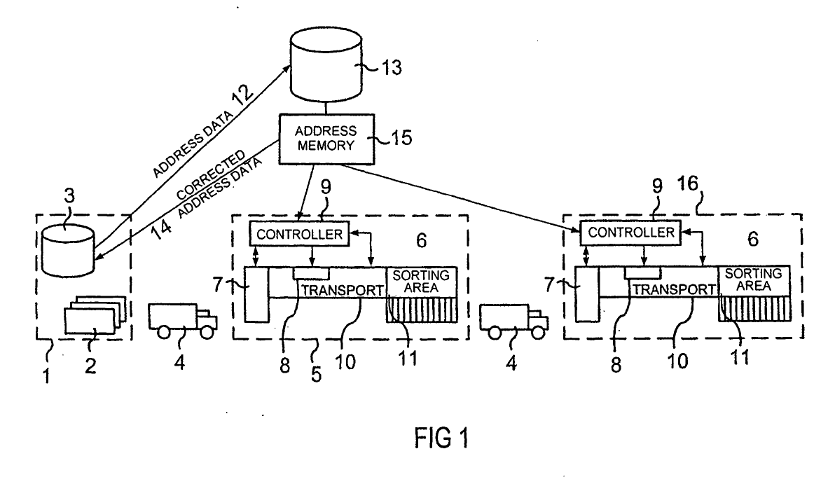

FIG. 1 shows a schematic illustration of a distribution system for bulk mailings with sent address data.

The sender 1 generates unaddressed mailings 2 for a bulk mailing and transports them to a competent distribution center 5 belonging to a postal service by HGV 4. The associated address data 12 from the address database 3 of the sender 1 are transmitted with an ID number electronically to an up-to-date central address database 13 belonging to the postal service. The address data for each mailing 2 are then compared with the entries in the postal service's address database 13. If the destination address data sent do not match the address entries for the respective identified recipient, these destination address data are corrected as appropriate. The checked and possibly corrected destination address data are then stored under the concomitantly transmitted ID number in a destination address memory 15. In the distribution center 5, the bulk mailing is loaded into a sorting machine 6 as first mailing processing machine. There, the mailings 1 are separated in a material infeed 7 and are supplied via a transport path 10 to a sorting area 11 in which they are sorted into mailboxes using routing arrangements.

On the transport path 10 there is a printing device 8 which is used to put the associated destination address details, including the name of the recipient, onto each mailing 2. So that printing and sorting can take place, the controller 9 in the sorting machine 6 needs to be able to access the bulk mailing's destination address data. To this end, the bulk mailing's packaging has an ID number on it which is either input into the controller 9 by the operator or is read in by a corresponding reader connected to the controller 9. Since the destination address data sent for this bulk mailing are likewise flagged with this ID number, the controller 9 in the sorting machine 6 is able to retrieve these destination address data under this ID number from a destination address memory 15 for bulk mailings.

In addition, the corrected destination address data 14 are transmitted with the associated ID number back to the sender 1, where they replace the incorrect entries in the latter's address database 3.

The controller 9 in the sorting machine 6 then associates the retrieved destination address data with the separated mailings 2 using loaded sorting schedules. In line with the respective association, the printing device 9 is actuated and the respective mailing 2 receives the corresponding address print, including the name. The association is made, by way of example, such that for each deliverer the mailings 2 are completed in the distribution order. This means that the sorting machine now needs to sort only for the deliverers and now needs to sort only a small portion for other distribution centers 16. The sequence also takes place in a corresponding manner in the other distribution centers 16, which also receive bulk mailings from a sender 1.

1. A method of distributing bulk mailing using a database and processing machines arranged to separate the bulk mailing at a start of processing, comprising the steps of:
receiving unaddressed bulk mailing;
receiving electronically communicating bulk mailing destination address data;
searching the database for a match to the destination address data and, in the event of there being no match, the destination address data is corrected;
associating the destination addresses data with individual mailings in the bulk mailing;
placing appropriate destination addresses onto the mailings in human readable form; and
processing the mailings in the mailing processing machine on the basis of the destination address data associated with each mailing.

2. The method according to claim 1, wherein each bulk mailing's destination address data which are sent with an ID number, are checked using a postal service's address database and are possibly corrected and stored under this ID number in a destination address memory and are retrieved therefrom by a controller in a mailing processing machine for associating the destination address data with the individual mailings and processing on the basis of the associated destination address data into which the same ID number, which also flags the unaddressed bulk mailing, has been input or read in.

3. The method according to in claim 1, wherein the database is continually updated on the basis of forwarding information.

4. The method according to claim 1, further comprising the steps of:
sorting the destination address data in the deliverers' distribution order; and
putting the destination addresses onto the mailings in the order.

5. The method according to claim 1, wherein the destination addresses are printed.

6. The method as to claim 5, wherein the destination addresses are additionally printed onto the mailings in coded and machine-readable form.

7. A method of distributing bulk mailing comprising the steps of:
sending unaddressed bulk mailing to a postal delivery service;
electronically communicating bulk mailing destination address data to the postal delivery service;
causing a searching of a database for a match to the destination address data and, in the event of there being no match, causing the destination address data to be corrected;
causing an associating of the destination address data with individual mailings in the bulk mailing;
causing a placing of appropriate destination addresses onto the mailings in human readable form; and
causing a processing of mailings in the mailing processing machine on the basis of the destination address data associated with each mailing.

8. The method according to claim 7, wherein each bulk mailing's destination address data which are sent with an ID number are checked using a postal service's address database and are possibly corrected and stored under this ID number in a destination address memory and are retrieved therefrom by a controller in a mailing processing machine for associating the destination address data with the individual mailings and processing on the basis of the associated destination address data into which the same ID number, which also flags the unaddressed bulk mailing, has been input or read in.

9. The method according to claim 7, wherein the database is continually updated on the basis of forwarding information.

10. The method according claim 7, further comprising the steps of:
causing a sorting of the destination address data in the deliverers' distribution order; and
causing the putting of the destination addresses onto the mailings in the order.

11. The method according to claim 7, wherein the destination addresses are printed.

12. The method according to claim 11, wherein the destination addresses are additionally printed onto the mailings in coded and machine-readable form.
